(19) United States
(12) Patent Application Publication
(10) Pub. No.: US 2002/0123989 A1
(43) Pub. Date: Sep. 5, 2002

(54) Real time filter and a method for calculating the relevancy value of a document

(76) Inventors: Arik Kopelman, Hod-Hasharon (IL); Guy Windreich, Rishon Lezion (IL); Michal Anvi, Tel Aviv (IL)

Correspondence Address: MERCHANT & GOULD PC, P.O. BOX 2903, MINNEAPOLIS, MN, 55402-0903, US

(21) Appl. No.: 09/799,322

(22) Filed: Mar. 5, 2001

(51) Int. Cl. G06F 7/00

(52) U.S. Cl. 707/3

(57) ABSTRACT

A method for calculating a relevancy value of a document out of a plurality of documents, the method includes the steps of: (a) receiving a client query defining an information interest of the client; (b) scanning each document with at least a portion of the client query and with at least one real time term to generate a first and a second set of relevancy values; a real time term are extracted from (i) information packets generated by real time information sources, (ii) other client queries or (iii) alert results, and (c) calculating a combination of relevancy values of the first and second sets of each document to generate the relevancy value of each document.

### RELATED APPLICATIONS

U.S. patent application Ser. No. 09/481,206 filed Jan. 11, 2000, U.S. patent application Ser. No. 09/655185 filed Sep. 5, 2000, and U.S. patent application Ser. No. 09/654801 filed Sep. 5, 2000.

### FIELD OF THE INVENTION

The present invention generally relates to real time filters and a method for calculating the relevancy value of a document.

### BACKGROUND OF THE INVENTION

Various filtering methods are known in the art. Most filtering methods are based on a predefined criteria. In real time computer environments, the relevancy of documents can change rapidly. The relevancy of document is usually correlated not just to predefined criteria but also to the content of real time generated terms, reflecting the currently relevant matters.

There is a need to provide an adjustable filtering scheme that reflects both predefined criteria and the content of real time generated materials.

### BRIEF DESCRIPTION OF THE DRAWINGS

The present disclosure will be understood and appreciated more fully from the following detailed description taken in conjunction with the drawings in which:

FIG. 1 is a simplified illustration of the environment in which the filtering system is operating, in accordance with a preferred embodiment of the present disclosure;

FIG. 2 is a simplified block diagram that illustrates one of the sources of real time terms—the Search Engine operations in association with related modules and data structures, in accordance with a preferred embodiment of the present disclosure;

FIG. 3 is a simplified block diagram that illustrates the structure of the Terms Index tables, in accordance with a preferred embodiment of the present disclosure; and

FIGS. 4-6 are flow chart diagrams illustrating a method for real time filtering.

### DETAILED DESCRIPTION OF THE PREFERRED EMBODIMENT

It should be noted that the particular terms and expressions employed and the particular structural and operational details disclosed in the detailed description and accompanying drawings are for illustrative purposes only and are not intended to in any way limit the scope of the invention as described in the appended claims.

The invention provides a method for calculating a relevancy value of a document out of a plurality of documents, the method consisting the steps of: receiving a client query defining an information interest of the client; scanning each document with at least a portion of the client query and with at least one real time term to generate a first and a second sets of relevancy values; and calculating a combination of the relevancy values of the first and second sets of each document to generate the relevancy value of each document.

The invention provides a method for real time document filtering wherein the step of receiving a client query is preceded by a step of receiving information packets and extracting real time terms from the information packets.

The invention provides a method for real time document filtering wherein the information packets are extracted from real time generated information streams from information sources.

The invention provides a method for real time document filtering wherein the information packets are extracted from other client queries.

The invention provides a method for real time document filtering wherein the information packets are extracted from currently generated alert results.

The invention provides a method for real time document filtering further consists a step of storing the real time terms in a storage means for a predetermined period of time; wherein the step of scanning consists a step of retrieving real time terms from the storage means.

The invention provides a method for real time document filtering wherein the step of receiving a client query is preceded by a preprocessing step selected from a group consisting of: adding control data to the information packets; filtering the information packets; adding control information to the filtered information packets; extracting real time terms from the filtered information packets; filtering the real time terms to generate real time terms; and storing the real time terms in a storage means.

The invention provides a method for real time document filtering wherein the control data consisting of at least one parameter selected from the group consisting of: (i) information packet identification; (ii) information source identification, (iii) time of arrival, (iv) alert identification; and (v) query identification.

The invention provides a method for real time document filtering wherein the real time terms are extracted out of the filtered information packets by parsing and stemming the plurality of information packets; and wherein the step of filtering further consisting a step selected from a group consisting of: (a) discarding said terms constructed of one-letter words; (b) discarding said terms constructed of frequently used words; (c) discarding said terms constructed of stop-words; and (d) discarding said terms constructed of predefined words.

The invention provides a method for real time document filtering wherein a reception of an information packet is followed by the steps of: storing information packet with an associated packet identifier in the storage means; storing real time term information representative of a reception of at least one real time term at the storage means; and linking between the stored information packet and the real time term information.

The invention provides a method for real time document filtering wherein a deletion of an information packet is followed by a step of deleting the linked real time term information.

The invention provides a method for real time document filtering wherein the information packet are stored in a messages hash, and wherein the linked real time term information is stored in a terms hash.

The invention provides a method for real time document filtering wherein the real time term information consisting of at least one information field selected from a group consisting of: a last modification time field, indicating a most recent time of reception of the real time term, during a predetermine period of time; a number of channels containing term, indicating a number of information sources that provided the real time term during a predetermine period of time; a total instances field, indicating a total amount of receptions of the real time term during a predetermine period of time; and a terms inverted entries map, consisting of a plurality of terms inverted file entries, each entry holding information representative of a reception of the real time term from a single information source during a predetermine period of time.

The invention provides a method for real time document filtering wherein each inverted file entry consisting of at least one field selected from a group consisting of:

a channel identifier, for identifying the information source that provided the real time term during a predetermine period of time; instances number, for indicating a total amount of receptions of the real time term from an information source during a predetermine period of time; and time of last appearance, for indicating a most recent time of reception of the real time term from an information source during a predetermine period of time.

The invention provides a method for real time filtering that further includes a step of filtering the real time terms such that real time terms that do not match a keyword out of a predefined list of keywords are discarded.

The invention provides a method for real time filtering that further includes a step of monitoring the reception of real time terms that not match a keyword out of a predefined list of keywords and providing the most frequently mentioned matching real time words.

The invention provides a method for real time filtering wherein each information packet is further associated to a message terms key map, said message key map consisting of a plurality of message characteristic entries, each message characteristic entry associated to an real time term being extracted from the information packet, said message characteristic entry consisting of at least one of the following fields selected from a group consisting of: a term inverted file, for pointing to the term extracted information; an instance of number, for indicating a number of time said real time term appeared in the information packet; and an inverted file entry, for pointing to a terms inverted file entry.

The invention provides a method for real time document filtering further consists the step of providing the client a query result reflecting the relevancy value of at lest some of the documents.

The invention provides a method for real time document filtering further consists the step of sorting the documents according to the relevancy value of each document.

The invention provides a method for real time document filtering further consists the step of monitoring a reception of real time terms to determine a set of most frequently received real time terms within a predefined period; and wherein scanning each document with at least a portion of the client query and with at least one real time term out of the most frequently received real time terms.

The invention provides a system for real time document filtering wherein information packets consiste of content selected from a group consisting of: text, audio, video, multimedia, and executable code streaming media.

In a computing environment running on a computer platform utilized as a central server system, the invention provides a method of calculating a relevancy factor of documents is operating in order to make available the capability for users of client systems connectable thereto of filtering documents in view of real time terms received by the central server system by sending client queries defining an information interest of the clients, the method consisting of the steps of: receiving a client query; scanning each document with at least a portion of the client query and with at least one real time term to generate a first and second sets of relevancy values; calculating a combination of relevancy values of the first and second sets of each document to generate the relevancy value of each document; and providing a query result reflecting the relevancy value of the documents.

The invention provides a method for real time document filtering wherein the step of receiving a client query is preceded by a step of receiving information packets and extracting real time terms from the information packets.

The invention provides a method for real time document filtering wherein the information packets are extracted from real time generated information streams provided by information sources coupled to the central server system.

The invention provides a method for real time document filtering wherein the information packets are extracted from other client queries.

The invention provides a method for real time document filtering wherein the information packets are extracted from currently generated alert results.

The invention provides a method for real time document filtering further consists a step of storing the real time terms in a storage means for a predetermined period of time; wherein the step of scanning consists a step of retrieving real time terms from the storage means.

The invention provides a method for real time document filtering wherein the step of receiving a client query is preceded by a preprocessing step selected from a group consisting of: adding control data to the information packets; filtering the information packets; adding control information to the filtered information packets; extracting real time terms from the filtered information packets; filtering the real time terms to generate real time terms; and storing the real time terms in a storage means.

The invention provides a method for real time document filtering wherein the control data consisting of at least one parameter selected from the group consisting of: (i) information packet identification; (ii) information source identification, (iii) time of arrival, (iv) alert identification; and (v) query identification.

The invention provides a method for real time document filtering wherein the real time terms are extracted out of the filtered information packets by parsing and stemming the plurality of information packets; and wherein the step of filtering further consisting a step selected from a group consisting of: (a) discarding said terms constructed of one-letter words; (b) discarding said terms constructed of frequently used words; (c) discarding said terms constructed of stop-words; and (d) discarding said terms constructed of predefined words.

The invention provides a method for real time document filtering wherein a reception of an information packet is followed by the steps of: storing information packet with an associated packet identifier in the storage means; storing real time term information representative of a reception of at least one real time term at the storage means, said at least one real time terms extracted from the information packet; and linking between the stored information packet and the real time term information.

The invention provides a method for real time document filtering wherein a deletion of an information packet is followed by a step of deleting the linked real time term information.

The invention provides a method for real time document filtering wherein the information packet are stored in a messages hash, and wherein the linked real time term information is stored in a terms hash.

The invention provides a method for real time document filtering wherein the real time term information consisting of at least one information field selected from a group consisting of: a last modification time field, indicating a most recent time of reception of the real time term, during a predetermine period of time; a number of channels containing term, indicating a number of information sources that provided the real time term during a predetermine period of time; a total instances field, indicating a total amount of receptions of the real time term during a predetermine period of time; and a terms inverted entries map, consisting of a plurality of terms inverted file entries, each entry holding information representative of a reception of the real time term from a single information source during a predetermine period of time.

The invention provides a method for real time document filtering wherein each inverted file entry consisting of at least one field selected from a group consisting of: a channel identifier, for identifying the information source that provided the real time term during a predetermine period of time; instances number, for indicating a total amount of receptions of the real time term from an information source during a predetermine period of time; and time of last appearance, for indicating a most recent time of reception of the real time term from an information source during a predetermine period of time.

The invention provides a method for real time filtering wherein each information packet is further associated to a message terms key map, said message key map consisting of a plurality of message characteristic entries, each message characteristic entry associated to an real time term being extracted from the information packet, said message characteristic entry consisting of at least one of the following fields selected from a group consisting of: a term inverted file, for pointing to the term extracted information; an instance of number, for indicating a number of time said real time term appeared in the information packet; and an inverted file entry, for pointing to a terms inverted file entry.

The invention provides a method for real time document filtering further consists the step of providing the client a query result reflecting the relevancy value of at lest some of the documents.

The invention provides a method for real time document filtering further consists the step of sorting the documents according to the relevancy value of each document.

The invention provides a method for real time document filtering further consists the step of monitoring a reception of real time terms to determine a set of most frequently received real time terms within a predefined period; and wherein scanning each document with at least a portion of the client query and with at least one real time term out of the most frequently received real time terms.

The invention provides a system for real time document filtering wherein information packets consiste of content selected from a group consisting of: text, audio, video, multimedia, and executable code streaming media.

The invention provides a method for calculating a relevancy value of a document out of a plurality of documents, the method consisting the steps of: receiving information packets; extracting real time terms form the information packets; storing the real time terms; receiving a client query defining an information interest of the client; scanning each document with at least a portion of the client query and with at least one real time term to generate a first and a second set of relevancy values; and calculating a combination of relevancy values of the first and second sets of each document to generate the relevancy value of each document.

The invention provides a method for real time document filtering wherein the real time terms are extracted from a group consisting of: real time generated information streams provided by information sources; other client queries; and currently generated alert results.

The invention provides a system for real time document filtering, the system is adapted to receive a client query originated by a client system, to receive a plurality of information packets, to extract real time terms from the information packets, and to generate query results reflecting a relevancy factor of documents of a data base of documents, the system for real time document filtering consisting:

an information packet processor, for receiving an information packet and for processing the information packet to generate at least one processed portion of the information packet; a storage means, coupled to the information packet processor and to a storage means, for temporarily storing information representative of a reception of the at least one processed portion of the information packet, the storage means are configured to allow fast insertion and fast deletion of content; a document storage means, for storing a plurality of documents; and a filter, coupled to the storage means and to the document storage means, for calculating a relevancy factor the plurality of documents and for providing a client query result representative of the calculated relevancy factor; wherein the relevancy factor reflects a correlation between (a) at least a portion of the query and (b) the at lest one processed portion of the information packet and between each document content.

The invention provides a system for real time document filtering wherein the at least one processed portion of the information packet is an at least one real time term.

The invention provides a system for real time document filtering further consisting at least one module selected from a group of modules consisting of: a message coordinator module adapted to coordinate an handling of a plurality of information packets; a message buffer adapted to hold temporarily the plurality of information packets; a message filter module for filtering the plurality of information packets according to predefined rules; a term extractor module for performing parsing and stemming on said plurality of information packets; a terms filter for excluding real time terms according to predefined rules; a queries coordinator module to coordinate the processing of client queries; a query-term extractor to parse and stem incoming queries in order to extract and process operative query-terms; and a query-terms filter for excluding specific query-terms in a predefined manner.

The invention provides a system for real time document filtering wherein the storage means is a term index data structure.

The invention provides a system for real time document filtering wherein the term index data structure is adapted to hold indexed real time terms and information packet identifiers.

The invention provides a system for real time document filtering wherein the term index data structure further consisting: a terms hash table to hold extracted, filtered and processed terms; a terms inverted file pointed to by said term hash table holding a terms inverted entry map; a messages hash table to hold information packets identification; a messages data table to hold information packets data; and

a channel map to hold a list of information sources and the related number of index terms of said information source.

The invention provides a system for real time document filtering wherein the terms inverted file further consisting: a terms inverted entries map table; a total instances of said term; a number of information sources containing said term; and a last modification time of said term.

The invention provides a system for real time document filtering further consisting: a message terms keyed map; an information source identification; and an information packet time of arrival.

The invention provides a system for real time document filtering wherein the message terms keyed map further consisting: a pointer to said terms inverted file; an instances number of said term in said information packet; and a pointer to said inverted file entry related to said term.

The invention provides a system for real time document filtering wherein the

terms inverted entries map further consisting an information source identification;

an instances number of said term in said information source informational content; and

a time of last appearance of said term in said information source informational content.

The invention provides a system for real time document filtering further consisting of at least one of the following means: adding means for adding control data to said information packets; filtering means for the plurality of information packets; processing means for said real time terms by adding control information to said real time terms; and term filtering means for the real time terms to generate filtered real time terms.

The invention provides a system for real time document filtering wherein the real time terms are extracted out of the plurality of information packets by parsing and stemming the plurality of information packets; and wherein the term filtering means are adapted to (a) discarding said terms constructed of one-letter words; (b) discarding said terms constructed of frequently used words; (c) discarding said terms constructed of stop-words; and (d) discarding said terms constructed of predefined words.

The invention provides a system for real time document filtering wherein the control data consisting of information packet identification, information source identification and time of arrival.

The invention provides a system for real time document filtering further adapted to receive an information packet, to store information packet with an associated packet identifier in an information packet storage means, store real time term information representative of a reception of at least one real time term, said at least one real time terms extracted from the information packet; and to link between the stored information packet and the real time term information.

The invention provides a system for real time document filtering further adapted to delete an information packet and delete the linked real time term information.

The invention provides a system for real time document filtering wherein information packet are stored in a messages hash, and wherein the linked real time term information is stored in a terms hash.

The invention provides a system for real time document filtering wherein the real time term information consisting of at least one information field selected from a group consisting of: a last modification time field, indicating a most recent time in which the real time term was received; a number of channels containing term, indicating a number of information sources that provided the real time term; a total instances field, indicating a number of times the real time term was provided; and a terms inverted entries map, consisting of a plurality of terms inverted file entries, each entry holding information representative of a reception of the real time term from a single information source.

The invention provides a system for real time document filtering wherein each inverted file entry consisting of at least one field selected from a group consisting of: a channel identifier, for identifying the information source that provided the real time term; instances number, for indicating a number of times the real time term was provided by an information source; and time of last appearance, for indicating a most recent time in which the real time term was received from an information source.

The invention provides a system for real time filtering wherein each information packet is further associated to a message terms key map, said message key map consisting of a plurality of message characteristic entries, each message characteristic entry associated to an real time term being extracted from the information packet, said message characteristic entry consisting of at least one of the following fields selected from a group consisting of: a term inverted file, for pointing to the term extracted information; an instance of number, for indicating a number of time said real time term appeared in the information packet; and an inverted file entry, for pointing to a terms inverted file entry.

The invention provides a system for real time document filtering further adapted to insert an real time term into a terms hash table and into a terms inverted file, insert an information source identification, said information source provided the real time term, to a terms inverted entry map table in said terms inverted file, insert information packet data in a messages hash table; insert the real time term from said information packet to a messages data table; increase a value of instances in said messages data table by one; and update a value of information source identification in said message data table.

The invention provides a system for real time document filtering further adapted to extract an real time term and accordingly to perform at least one operation selected from a group consisting of: increase a value of total instances in said terms inverted file; update a value of last modification time in said terms inverted file; increase a value of instances number in said inverted entry map table associated with said information source identification in said terms inverted file; and update a value of message time in said messages data table.

The invention provides a system for real time document filtering further adapted to delete an information packet, and accordingly to perform at least one operation selected from a group consisting of: receive an information packet identification, whereas the terms extracted from the information packets are to be deleted; read the information packet identification from the messages hash table in said terms index data structure; obtain relevant entries of said real time terms belonging to said information packet in said messages data; and access said terms inverted file for each said terms entry pointed to said terms inverted file.

The invention provides a system for real time filtering that is further adapted to store alert criteria and to match alert criteria received and processed in the past against newly received terms to generate an alert.

It should be noted that the particular terms and expressions employed and the particular structural and operational details disclosed in the detailed description and accompanying drawings are for illustrative purposes only and are not intended to in any way limit the scope of the invention as described in the appended claims.

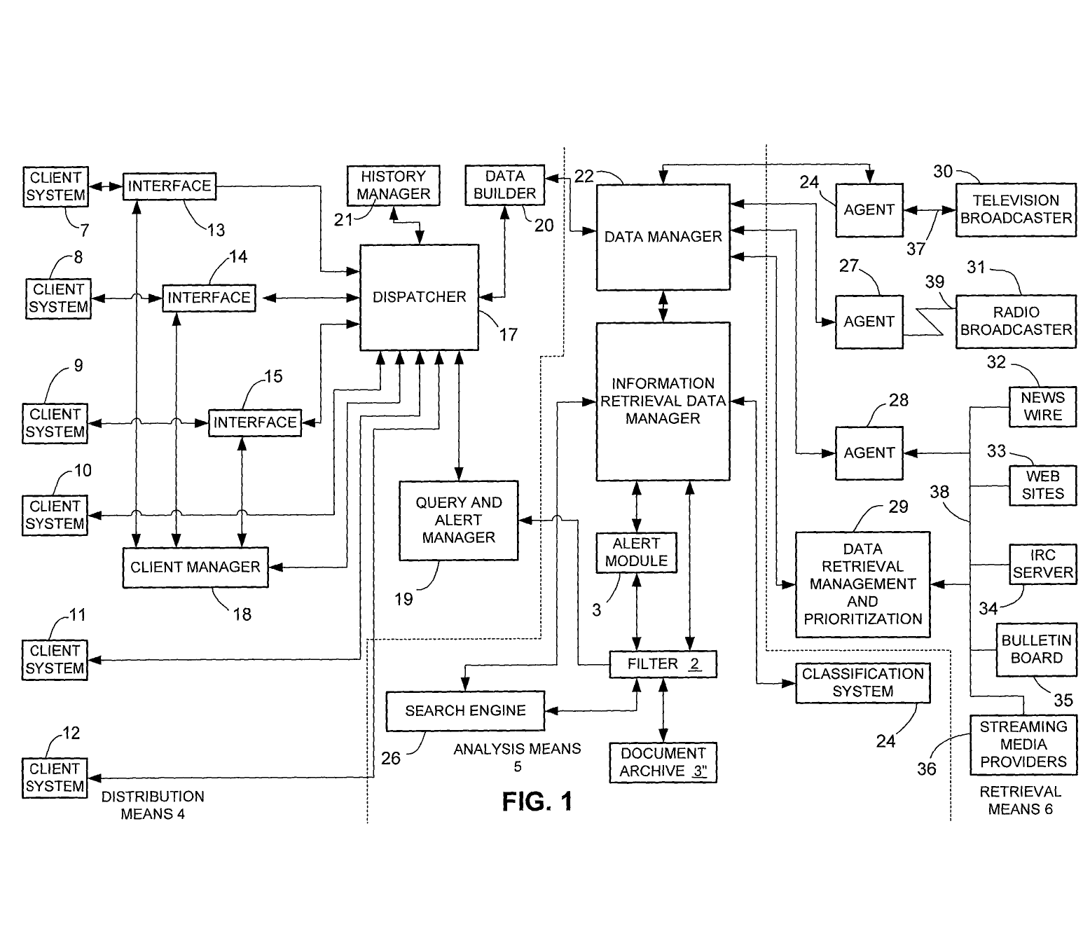

Referring to FIG. 1 describing system 1 in which filter 2 operates, according to a preferred embodiment of the invention. System 1 includes distribution means 4, analysis means 5, retrieval means 6, and a database of documents 3.

Client systems 7, 8, 9, 10, 1 1 and 12 provide client queries to system 1. Client systems are coupled to system 1 via a network and a plurality of interfaces, such as interfaces 13, 14 and 15. For convenience of explanation it is assumed that client system 7 is a personal computer system, client system 8 is a cellular phone, client system 9 is a PDA, client system 10 is a set top box coupled to a digital television, client system 11 is adapted to receive electronic mail. Accordingly, interfaces 13-15 are adapted to provide query results in various formats, according to various communication protocol, such as the TCP/IP protocol. For example, client system 8 can receive query results and alerts in WAP format. Usually, a client system receives a query result including of text, audio stream, video stream. Such a query result often includes of a URL address, for allowing a client system to access desired information via a network such as the internet.

It is assumed that a client system can provide a client query and/or can update an alert criteria. System I accordingly provides said client system with a query result and/or an alert.

Conveniently, distribution means 4 including of interfaces 13-15, client manager 18, dispatcher 17, history manager 21, query and alert manager 19 and data builder 20. Client manager 18 holds client profiles. A client profile can indicate which queries were provided by the client system, at least one format in which either a query result and/or an alert is to be sent to a client system, a client identifier ID, and a list of alert criteria. Client Manager 18 manages user profiles and provides queries or alert criteria to alert engine 3 via query and alert manager 19. Each query/ alert criteria is associated with said client ID. Conveniently, client manager 19 holds a table for mapping alerts to client systems.

Distribution means 4 interfaces between clients and the analysis means 5. Dispatcher 17 and interfaces 13-15 are adapted to receive client queries and/or alert criteria from client systems 7-8, to update client profiles and send said client queries/alert criteria to analysis means 5. Query results and/or alerts are generated by analysis means 5 and dispatched to client systems by distribution means 4.

Dispatcher 17 receives from client manager updated alert criteria and/or client queries and provides them to query and alert manager 19. Dispatcher 17 receives alerts and query results and in association with client manager 18 determines to which client system to send said alert and/or query result and in what format. Said alert and/or query result are provided to one of interfaces 13-15 and to the appropriate client systems. Dispatcher 17 receives query results and alerts from analysis system 5 via query and alert manager 19. In response to a reception of an alert or a query result, dispatcher 17 in association with client manager 18 determine which information to include in a query result or alert to be sent to a client system. Accordingly, a content object request is sent to data builder 20.

Real time terms can be extracted from alert results, client queries and information packets from various information sources, such as sources 30, 31, 32, 33, 34, 35 and 36. As indicated by dashed lined pointing to filter 2 and from filter 2, filter 2 can fetch or receive real time terms from search engine 26, alert module 3, query and alert manager 19. The real time terms can also be sent to filter 2 from other elements of system 1, such as from dispatcher 17, but for convenience of explanation dashed arrows coupling the elements are not shown. Filter 2 is also coupled to archive 3″ that holds the documents to be filtered. The documents can be provided to the archive in various manners. According to one aspect of the invention at least some of the documents are provided by information sources, such as information sources 30-35 and are stored at archive 3″ as soon as they are provided to analysis means 5″. A document can be provided in parallel to archive 3″ and to search engine 26 and alert module 3. Accordingly, real time terms extracted from the document can influence a filtering process of the document.

Data builder 20 accesses data manager 22 and provides dispatcher the requested information. For example, an alert can indicate that information source 30 provided at least one matching information packet that matches an alert criteria of client system 10. Dispatcher receives said alert and determines, in association with client manager 18 that the alert should contain additional information from the matching information source 30, such as a multimedia stream that was broadcasted by information source 30, whereas the matching information packets were driven from said multimedia stream.

Dispatcher sends data builder 20 a content object request to receive said multimedia stream. Said request usually determines the matching information ID and a content type/alert or query result format. Said multimedia stream is stored in a certain address within data manager 22, or in an external multimedia server (not shown). Said content object request to receive said address. Said address is provided to dispatcher 17 and via interface 13 and network 16 to client system 10. Eventually, said multimedia stream in displayed upon a screen of a digital television.

Conveniently, distribution means 4 maintains a list of distributor identifications ID, distributor type and user counter for each alert.

Client manager 18 is adapted to manage client system information such as client system profile, preferences, and alert criteria.

History manager 21 is adapted to maintain alert criteria and requests to update said criteria for client retrieval. History manager 21 receives requests to update an alert criteria from dispatcher 17 and stores said requests, for allowing a client system to view said requests.

Query and alert manager 19 routes client queries and alert criteria updates from dispatcher 17 and routes query results and alerts from analysis means 5 to dispatcher 17.

Retrieval means 13 including of a plurality of agents or receptors, such as agents 24, 27, 28 and 29. Said agents are coupled to various information sources, such as information sources 30-36 via networks 37 and 38 or via media 39. Agents 24, 27, 28 and 29 are adapted to receive information from various information sources, such as television channel 30, radio channel 31, news provider 32, web sites 33, IRC servers 34, bulletin boards 35 and streaming media provider 36, and provide information packets to analysis means 5. For example, agent 24 receives television broadcasts or video streams via cable network 37 and convert the television broadcast or video stream to a stream of information packets. Agent 24 can include of a dedicated encoder, a device for extracting clause caption out of said video stream or picture recognition and analysis means. Agent 27 receives radio broadcasts, transmitted by radio channel 31 over a wireless media, and convert said transmitted audio stream to a stream on information packets. Agent 28 is coupled, via network 38 to news provider 32, web sites 33, IRC servers 34, bulletin boards 35 for retrieving information packets transmitted from said information sources via network 38. Retrieval means 6 further including of retrieval management and prioritization component 29 for prioritizing content sources and channels and for balancing the load between agents/receptors.

Real time alert engine 3 is adapted to receive alert criteria from query and alert manager 19 and to constantly match said alert criteria against portions of received information packets, said information packets provided by retrieval means 6. When an alert criteria is fulfilled, an alert indication is provided to query and alert manager 19. Conveniently, said alert indication including of a query ID and an information packet ID. Dispatcher 17 receives said alert indication accesses client manager 18 to determine which client system is to receive an alert, what additional information to provide said client system and in what format to sent the alert to said client system. Accordingly, dispatcher sends an result object request to data builder 20. Data builder 20 accesses data manager 22, receives the additional information, provides said information to dispatcher 17, and provides an alert to a client system, via an interface and network 16.

Data Manager 22 is adapted to store received information packets, audio streams and video streams. Optionally, data manager 22 is further adapted to allow data clients to get notification on data events such as data changes, data expiration, etc. and is further adapted to allow data providers to register as such.

Real time alert engine 3 allows to generate alerts in real time, in response to previously provided alert criteria and information packets being received in real time. Real time alert engine is adapted to support various alerts, such as Boolean alerts and best effort alerts.

Real time search engine 26 allows to generate query results in real time. Real time search engine 26 is adapted to support various searching techniques, such as Boolean search and best effort search.

Classification module 24 is adapted to dynamic classification of information streams/groups of information packets. Classification module 24 dynamically determines a topic of a channel, thus allowing searches and alerts based upon a topic an information stream.

Filter 2 receives client queries via dispatcher 17 and is configured to: (a) scan each document within database 3 with at least a portion of the client query and with at least one real time term to generate a first and a second relevancy values, (b) calculate a combination of the first relevancy value and the second relevancy value of each document to generate the relevancy value of each document. Filter 2 is further configured to provide the client a query result, via distribution means 4, that reflects the relevancy value. The query result can include a list of sorted documents, from the most relevant document to the least relevant document, and can include links to the documents. Links are provided when the document data base can be accessed by a client system, in an analogues manner to the access to information within data manager 22.

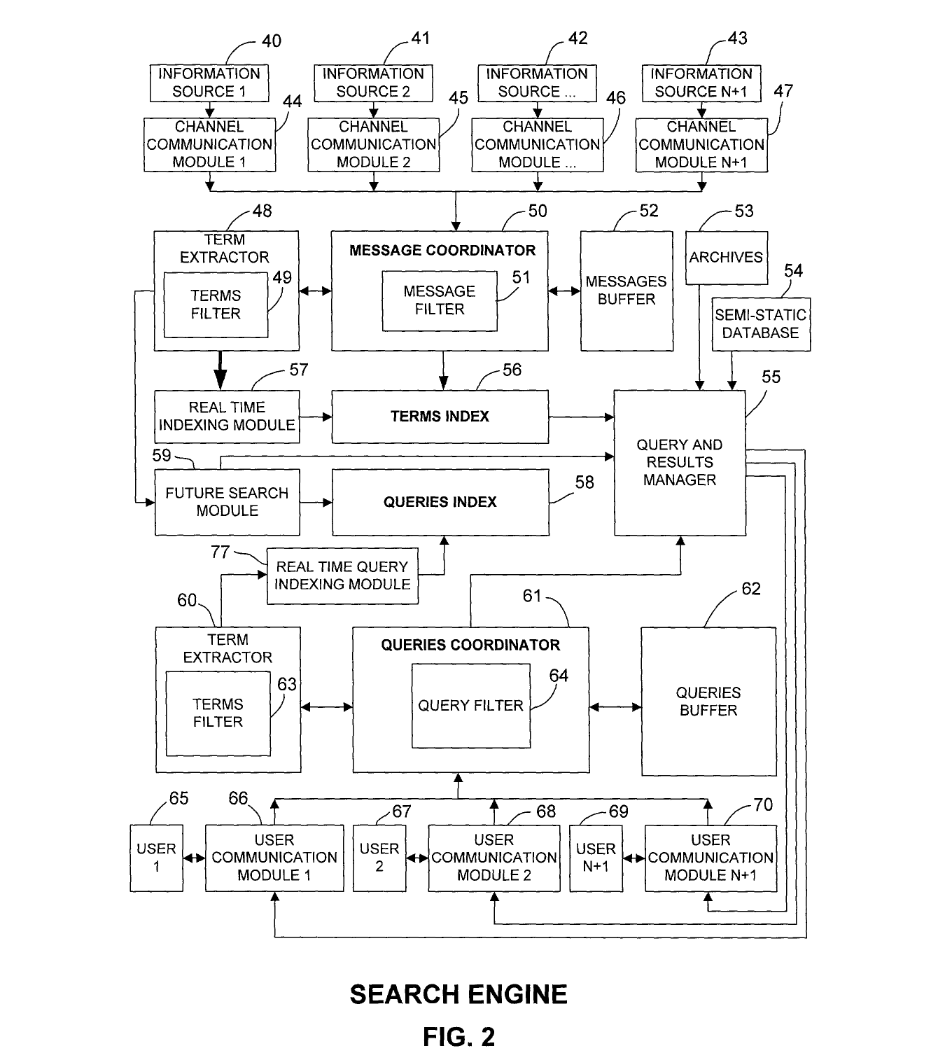

Referring now to FIG. 2 where the various software modules and data structures necessary for the operation of the Search Engine are shown. Search engine 26 is configured to provide real time terms that were retrieved by retrieval means 6. The operation of the search engine is described at U.S. patent application titled “System and Method for Real Time Searching”, Ser. No. 09/655185, filed at Sep. 5, 2000 and assigned to eNow Inc., is incorporated in its entirely by reference.

A system and method for generating alerts and providing alerts results is described at U.S. patent application titled “System and Method for Real Time Alerts”, Ser. No. 09/654801 filed at Sep. 5, 2000 and assigned to eNow Inc., is incorporated in its entirely by reference.

Although not part of the Search Engine, for the clarity of the disclosure only Information Sources 40, 41, 42, and 43 are shown connected to channel communication modules 44, 45, 46, and 47. For clarity of the disclosure FIG. 2 does not illustrate some portions of the distribution means 4, retrieval means 6 and analysis means 5 of FIG. 1.

FIG. 2 illustrates various optional modules/portions of search engine 26, such as, but not limited to, query index 58, real time query indexing module 77, archive search module 53, semi-static database search module 54, query coordinator 61 query filter 64, message coordinator 50, message filter 51, terms filters 49 and 63. Search engine 26 has: Message Coordinator module 50, Message Filter module 51, Messages Buffer 52, Term Extractor modules 48 and 60 Terms Filter modules 49 and 63, Real Time Search modules 57 and 77, Terms Index 56, future search module 59 for allowing a generation of real time alerts to a client system, queries Index 58, query and results manager 55 user communication modules 66, 68, and 70, queries coordinator 61, query filter module 64, archive search module 53, and semi-static database search module 54. Although no part of the Search Engine, for the clarity of the disclosure only, Users 65, 67, and 69 are shown connected to User Communication modules 66, 68, and 70. Query and results manager 55 matches query results to terms index 56 to generate query results. Query and results manager 55 matches alert criteria provided by future search module 59 to the content of terms index 56. Future search module also referred to as alert module 59. In the preferred embodiment of the present disclosure, one information source may be a television channel that provided multimedia streams, that are later transformed into streams of information packets messages. It should be understood that in the following discussion of the present disclosure the general framework of television channels is used for purposes of description not limitation. Said search engine received text that is being either associated to the content of television channels or driven out of a multimedia stream provided by television stations. Text can be driven from a multimedia stream by various means such as special encoders, voice recognition means. Many television channels provide text in a format of clause caption. Although information packets will be referred to as messages, and information sources will be referred to as channels in the text of this document, it will be appreciated that in different embodiments of the present disclosure other sources of information could be used such as news channels, video channels, music channels, various Internet sites and the like. It will also be appreciated that in other embodiments of the present disclosure, the information packets processed could be in addition to text format in other diverse data formats such as streaming video, still pictures, sound, applets and the like.

The data messages/data packets from the various channels are received through Channel communication modules 44, 45, 46, and 47 into the Search Engine module and processed therein. Channel communication modules 44, 45, 46, and 47 build and transfer the messages to Messages Coordinator Module 50 for processing. The messages transferred consist of control data such as channel ID, Message ID, timestamp of the time of arrival, and information content such as a phrase, a sentence, a news item, a music item or a video item.

Messages Coordinator 50 coordinates the handling of the incoming messages, and provides processed messages to term extractor 48 and to messages buffer 52. Messages Buffer 52 is a data structure that temporarily holds the incoming messages. In the preferred embodiment of present disclosure Messages Buffer 52 is a cyclic buffer. Message Filter 51 filters messages according to user-defined rules. For example, messages with a specific channel ID or messages containing specific text might be blocked and discarded.

Term Extractor 49 receives the messages from Messages coordinator 48, performs message parsing, and stemming (finding the lexicographic root) of the resulting terms. Once the message is parsed and stemmed, a list of terms within said message is created. The terms extracted are sent to further processing accompanied with identifying data such as channel ID, message ID and the message arrival time. Terms Filter 49 passes the terms through a series of filters, which can change or discard specific terms. For example, Terms Filter 49 can discard stop-words, frequently used words, one-character words, user-defined words, system-defined words such as “a”, “about”, “else”, “this”, and the like.

Real Time Indexing Module 57 accepts and stores the terms into Terms Index 56. Real Time Indexing module 57 also schedules and initiates periodically a process that removes irrelevant or time-decayed terms from Terms Index 56. Description of the process will be set forth hereunder.

Terms Index 56 consists of indexed terms and message identifiers that point to information relating to a reception of said messages and indexed terms during a predetermined period of time. Terms Index 56 is designed to enable fast term indexing and deletion. The indexing is done per term, while deletion is done per message. When the message is discarded for becoming irrelevant or time-decayed, all terms that refer to this message are deleted from Terms Index 56. Terms Index 56 is a means to realize real time search of real time content that is one of the search capabilities of the Search Engine module.

Alert module 59 functions in conjunction with Queries Index 58. Unlike real time Indexing module 57, alert module 59 matches incoming terms from the message stream against a database of more or less static queries. Therefore, alert module 59 has the ability to search for a term that is relevant to a query that was initiated at some point in time in the past as long as the relevant query is kept in the Queries Index 58. Alert module 59 enables the return of query results during a predefined time frame that begins at the query's arrival time.

Queries Index 58 holds queries for a predefined time frame in order to provide the means to alert module 59 to match terms of queries against the terms of the incoming messages. Queries Index 58 enables to return future results to queries.

According to one preferred embodiment of the invention, queries are inserted into queries Index 58 by queries coordinator 61. According to another preferred embodiment of the invention said queries also pass query terms extractor 60 and real time query indexing module 60, and undergo preprocessing steps that are analogues to preprocessing steps of a massage. Queries can contain several terms. Therefore, the relevant control information associated with each query such as query ID, timestamp and the like is indexed against all the terms of the query.

Query and Results Manager module 55 handles the queries and provides return of results to the queries by establishing a unified result from all the result sources except from Future search module 59. Result sources are the following: (a) search in Real Time Indexing module 57, (b) search in the Semi-static database by semi-static database search module 54, and (c) search in the Archive database by archive search module 53. The results from future search module 59 are passed through the Query and Results Manager 55 that sends the results on to the users 65, 67, and 69 via User communication modules 66, 68, and 70. Typically, a result consists of a sorted list of channel IDs and a score for each channel that mirrors a channel/query match. User Communication modules 66, 68, and 70 communicate between the Search Engine module and the users 65, 67, and 69. For each user 65, 67, and 69, a new instance of communication module 66, 68, and 70 is activated. User communication modules 65, 67, and 69, transfer queries initiated by the users to the Search Engine module and return results back to the users.

When a complex search is performed, query and search manager 55 analyses information regarding a various receptions of information packet, said information packets originating from a single information source.

Queries Coordinator 61 functioning similarly to Messages Coordinator 50 only with queries instead of messages. Queries Coordinator 61 receives queries from user communication modules 66, 68, and 70 and inserts the queries into the Queries Buffer 62. Upon a request from Query and Results Manager 55 Queries Coordinator 61 fetches one query from queries buffer 62 and passes it via Terms Filter 63 to Term Extractor 60. The real time terms of the query are inserted by real time query indexing module 77 into Queries Index 58.

According to one preferred embodiment of the invention, queries Buffer 62 holds the queries in the same manner as the messages are held in the Messages Buffer 52. Queries Buffer 62 is a data structure that temporarily holds the incoming queries. In the preferred embodiment of present disclosure Queries Buffer 62 is a cyclic buffer.

It will be appreciated that other forms of search could be contemplated in other embodiments such as thesaurus-mode search or historical-mode search. Therefore, the above description should not be interpreted as a limitation to the present disclosure.

The operation of the Search Engine module will be described next. Information packets such as chat messages are extracted out of an incoming information stream from specific information sources such as IRC channels by channel communication modules 44, 45, 46, and 47. The messages are structured, times-stamped and transferred to the operative modules of the Search Engine. The structured messages contain control data such as channel ID, message ID, time stamp indicative of the time of arrival and content information such as textual data. The messages transferred through Message Filter 51 which blocks specific messages according to predefined rules. For example, messages originating in particular channels or having specific text content or having particular characteristics could be discarded. The filtered messages are inserted into Messages Buffer 52 which is managed and synchronized by Messages Coordinator 50. Messages coordinator 50 operates in conjunction with Messages Buffer 52, which is designed to hold the messages to be retrieved for later processing. Messages Buffer 52 is a cyclic buffer. Incoming messages are inserted at one end of the Messages buffer 52 while retrieved from the other end. The messages are kept in the buffer for a predefined period of time. Time-decayed messages may be discarded. In other embodiments of the disclosure, other methods could be used to delete messages from Messages Buffer 52 such as deletion by predefined priorities. For example, messages from a specific low-priority channel could be discarded first. When a message is deleted from message buffer 52 information relating to the reception of real time terms that were extracted from said messages are deleted from term index. Messages are provided by message coordinator 50 to Term Extractor 48. Term Extractor 48 performs message parsing, stemming (finding the lexicographic root) of the resulting tokens and extracts the tokens from the messages. The tokens are transferred through a series of Terms Filters 49. Terms Filters 49 can change or discard a token according to predefined parameters. For example, Terms Filters 49 can discard stop-words, one-letter words, frequently used words, user-predefined words and the like.

The tokens are structured into operative terms to be used by other Search Engine modules after Term Extractor 48 attaches identifiers to the tokens such as channel ID, message ID and time of arrival. Finally, Term Extractor 48 dispatches the terms to real-time Indexing module 57.

The purpose of Real-time Indexing module 57 is to provide a search capability of text received in the close past. Real Time Indexing module 57 receives the terms from Term Extractor 48 and stores the operative terms into Term Index 56 which is a dynamic data structure designed to cope with the requirement for fast indexing of terms and for fast deletion of all references to terms related to a specific message. In addition, real-time Indexing module 57 performs a periodic scan for non-used terms in Terms Index 56. Non-used terms are defined as terms that are not referenced for a predefined period of time. Periodically, a garbage collection process is initiated by real-time Indexing module 57 in order to delete the non-used terms.

The search-related element of Terms Index 56 is a data structure containing entries indexed by terms and holding the terms related information such ass a channel ID. As a result, fast insertion and indexing of terms is accomplished.

A more detailed description of the operations related to inserting terms and removing terms from Terms Index 56 will be set forth hereunder in association with the related drawing.

Queries are initiated by users. User communication modules 66, 68, and 70 transfer the queries from the user into the Search Engine modules. Queries hold one or more terms. Conveniently, the handling of a query by the Search Engine modules is analogues to the handling of an incoming message. Queries are filtered by Query Filter 64, and handled by Queries Coordinator 61. Queries Coordinator 61 functions in respect to the incoming queries in a like manner to Messages Coordinator 50 functions in respect to the incoming messages. Queries Coordinator 61 receives the queries from user communication modules 66, 68, and 70 and transfers the queries to the Term Extractor 60. Term Extractor 60 parses the queries and stems the resulting tokens. The tokens are filtered by a series of Terms Filters 63, structured into query-terms by the attachment of control information such as query Id and time-stamp and returned to Queries Coordinator 61 to be inserted into Queries Index 58 in order to be matched later against the operative terms in Terms index 56.

Queries Index 58 holds query-terms for a predefined period of time to enable queries to be matched against the stream of incoming message terms. Queries index 58 thus provides the capability to collect future results to queries. The above mentioned capability is accomplished in conjunction with the Future Search module 59.

Future Search module 59 operates in conjunction with the Queries Index 58 by matching terms from incoming stream of messages against a database of relatively static queries. Said data base can hold alert criteria, and system 1 can dispatch an alert to a client system when an alert criteria is matched. Subsequently a query that was initiated in the past can be matched against newly inserted terms as long as the query is kept in the Queries Index 58. This type of search is defined as the “future search mode” in contrast to the “real-time search-mode”.

Query and Results Manager 55 handles the query-terms and provides query results by fetching query-terms from Queries Index 58 through Queries Coordinator 61, dispatches the query-terms to the different result sources, collects the results and builds a unified result to be sent back to the user that initiated the original query.

There are three operative result sources/three matching modes: (a) Real-time search, (b) Archive search, and (c) semi-static database search. Although the Future search functions separately from the other result sources in a different embodiment of the present disclosure future search results may be unified with the search results.

Query and Results Manager 55 establishes a unified result from all result sources (excluding future-search-mode). Query and Result Manager 55 sends the results to the users structured as sorted lists of channel IDs and a score for each channel representing a channel/query match.

Scoring, or ranking of channels to be returned as a result, is done using a model that computes the similarity between the query and the channel. Some of the parameters involved in computing the results are: Total amounts of terms in channel in the predefined time interval, number of relevant terms in the channel in the predefined time interval, total number of channels searched in the predefined time interval, elapsed time since the last appearance of the relevant term in the channel in the predefined time interval and relevant terms position in the channel. Additional factors for the score: terms in proximity to relevant term, part of speech of relevant terms, relevant term frequency and importance in the language of the channel.

The parameters enable Query and Results Manager 55 to rank the resulting channels, in addition to standard ranking methods by the time parameter as well by giving more weight to phrases than to the collection of single words.

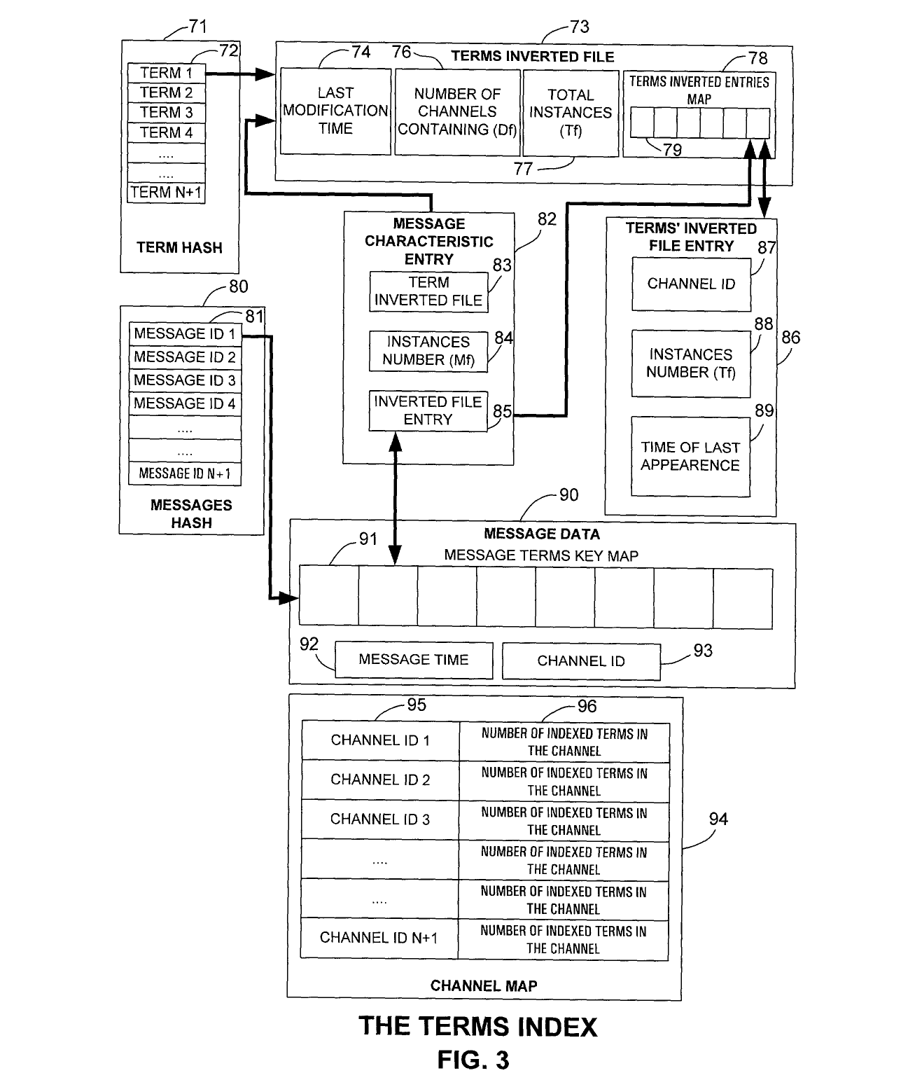

Referring now to FIG. 3 that illustrates the structure of the Terms Index 56 tables. The Terms Index consists of two main units: The Terms Hash 71 and the Messages Hash 80. Additionally Terms Index contains the Channel Map unit 94.

Terms Hash 71 includes the Term table 72 and the associated Terms Inverted File 73. The Term Hash 71 includes of entries whose keys are terms. Therefore, Term Hash 71 provides fast access to the entries by using terms as access keys. The said structure also provides for fast insertion of terms into the table.

The Terms Inverted File 73 includes of a sorted list of Terms Inverted Entries Map 78 and at least one of the following files: (a) a total number of references (Total Instances) 77 to the term in all the messages currently stored in Messages Buffer 52 of FIG. 2, (b) the modification time of the term (Last Modification Time) 74, or (c) a number of channels that contain the term 76. Each entry, such as entry 786 in Terms Inverted Entries Map 78 is keyed by the channel ID 87 and has the number of references (Instances No) 88 to the term in that channel and the time of the last appearance of the term in the channel (Time of Last Appearance) 89. The number of references that are added to the Total Instances 77 could be used to determine the channel's relevance to a specific query.

Messages Hash 80 indexed by Message ID 81 in order to provide fast deletion of term's references by message. Messages Hash 80 includes Message ID table 81 and the associated Message Data table 90. Each entry in Message Data table 90 contains information about one message and pointed to by a Message Hash entry 81. Message Data table 90 consists of (a) the channel ID 93 (b) message time 92, and (c) Message Terms Keyed Map 91. The Message Terms Keyed Map 91 is a sorted list of Message Characteristics Entries 82. A pointer 83 keys each entry, which is unique to each term. Therefore, a Message Characteristics Entry 82 can be found easily by a specific term. Message Characteristics Entry 82 contains the following information: (a) the number of times the related term was referred to in the relevant message (Instances No) 84, and (b) a pointer to the related Inverted File Entry 85.

The Channel Map 94 is a list sorted by channel IDs 95. For each channel ID 95, Channel Map 94 holds the total number of currently indexed terms that belong to the channel 96. In the preferred embodiment of the present disclosure, said total number relates to the number of terms after filtering. In a different embodiment of the present disclosure, the total number could relate to the number of terms before filtering or to the average of both values.

The operations supported by the Terms Index 56 of FIG. 2 will be described next. Terms Index 56 of FIG. 2 supports three modes of operation: (1) term insertion, (2) terms deletion by message ID, and (3) term deletion by the garbage collection process.

Term insertion is performed by Term Extractor 48 of FIG. 2 when handling a newly real time term from an incoming message. The term is indexed in this mode of operation by Term, Message Id, Channel Id and Message Time. When inserting a Term the following sequence of steps is performed:

One) the Term 72 to Terms Inverted File 73 link is accessed or created. A pointer to Terms Inverted File (invertedFilePtr) is saved.

Two) the Total Instances 77 member's value in Terms Inverted File 73 pointed at by invertedFilePtr is increased by one.

Three) the Last Modification Time 74 member in Terms Inverted File 73 pointed at by invertedFilePtr is updated.

Four) the entry for channel Id 87 in Terms Inverted Entries Map 79 is accessed or created. A pointer to the entry is saved as invertedFileEntryPtr.

Five) the value of Instances No 88 member in the entry pointed at by invertedFileEntryPtr is increased by one.

Six) the appropriate Message Data is accessed or created in Message Hash 80. A pointer to the entry is saved as messageData.

Seven) the Message Characteristic Entry 82 in Message Data 90/Message Terms Keyed Map 91 is accessed by invertedFilePtr or created. A pointer to the entry is saved as messagecharac.

Eight) in the entry pointed at by messagecharac the value of Instances Number 84 member is increased by one.

Nine) in the entry pointed at by messageCharac, the invertedFileEntry pointer is set to point at invertedFileEntryPtr.

Ten) in the Message Data 90, the Message Time 92 member is updated.

Eleven) in the Message Data 90 the channel ID 93 member is updated.

Term deletion by Message Id occurs when a message is deleted. A message can be deleted when the Messages Buffer 52 of FIG. 2 is full or a predetermined time interval indicative of the period a message should be kept in the buffer 52 has been completed. For term deletion by Message Id the following sequence of steps is performed:

One) the appropriate Message Terms Keyed Map 91 is obtained from Messages Hash 80.

Two) for each Message Characteristics Entry 82 that points to Terms Inverted File 73:

Three) the pointed Terms Inverted File 73 is accessed and Total Instances 77 member's value is decreased by the Instances No 84 member's value in Message Characteristic Entry 82.

Four) the Term Inverted Entry 86 is accessed and the Instance Number 88 value is decreased by Message Characteristic Entry's local Instances No member 84 value.

Five) Message Characteristic Entry 82 is deleted.

Six) steps ‘c’ through ‘e’ are repeated until Message Terms Keyed Map 91 is empty.

Seven) the Message Id 81/Message Terms Keyed Map 91 link is deleted.

Deleting a term not via Message Id 81 is done periodically by the garbage collecting process. The deletion is performed if the term's last modification time occurred before a specific point in time in the past which implies that there are currently no messages that the specific term refers to or that the term's Total Instances 77 member's value equals zero. When a term is found that satisfies the above conditions a simple deletion of the Term 72 to Terms Inverted File 73 link is performed.

Conveniently, system 1 can provide real time alert by various manners. According to a first embodiment of the invention, future search module 59 matches a plurality of alert criteria against the content of terms index 56. According to a second embodiment of the invention, terms index 56 has additional field, associated to each term, indicating whether said term is a part of an alert criteria or not. If so—said term is not deleted from terms hash 71 unless a client system requested to delete it. When a real time search is performed, the whole content of the terms hash is checked, while an alert is based upon a check of only the terms identified as a part of the alert criteria.

According to an aspect of the invention, each document is compared to a selected subset of the real time term stored in search engine 26. The selection can be based on various criteria. For example, the subset can include the N most frequently mentioned real time terms, a set of terms that are related to predefined topics of interest, a set of real time terms ate correlate to the clients profile. Search engine 26 can monitor the reception of real time terms and provide the subset of most frequently mentioned real time terms.

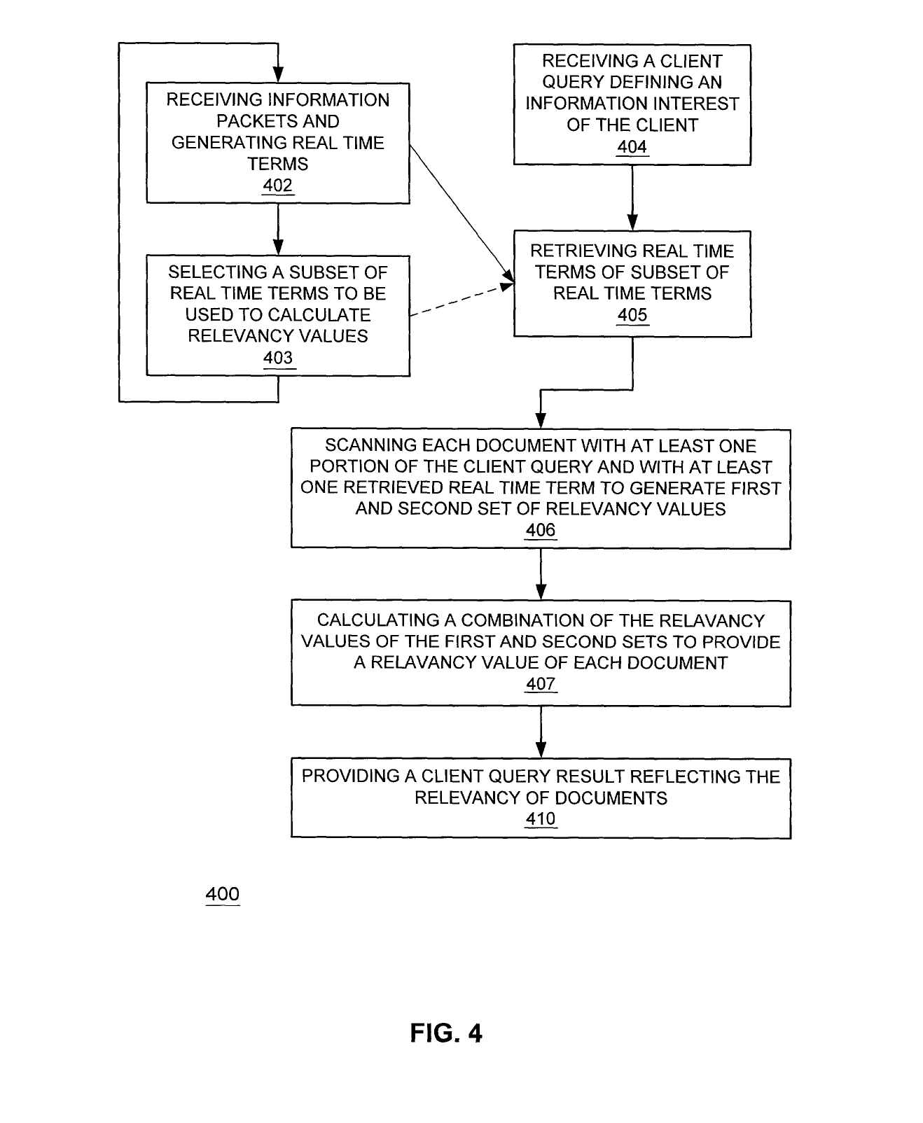

FIG. 4 is a schematic flow chart illustrating a method 400 for calculating a relevancy value of a document out of a plurality of documents, in accordance with a preferred embodiment of the present invention.

Method 400 starts with steps 402 and 404. Step 402 of receiving information packets and generating real time terms. The information packets are extracted from (a) real time generated information streams from information sources, and/or (b) other client queries, and/or (c) currently generated alert results. Referring to the example set forth at FIG. 1, real time information streams are originated by information sources 30-36 and retrieved by retrieval means 6. Other client queries are originated by client 7-12 and provided by distribution means 4 to the analysis means 5. Currently generated alert results are generated by alert module 3 in response to alert criteria provided by client systems 7-12. Real time terms originating from information sources are processes by search engine 3, as illustrated at FIG. 2-3. Real time terms are either constantly provided to filter 2 or are accessible to filter 2. Step 402 is executed in parallel to steps 404-410 so that the real time terms are constantly received, so that when a client query is received by filter 2, filter 2 can filter a document with the most recently received real time terms.

According to one embodiment of the invention, step 402 is followed by step 403 of selecting a subset of real time terms to be used to calculate relevancy values. This subset can include the most frequently mentioned real time terms. According to one aspect of the invention the subset includes only real time terms that match a predefined list of keywords. According to another aspect of the invention the subgroup includes the most frequently mentioned keywords out of a list of predefined keywords. Referring to the example set forth in FIG. 2-3, search engine 26 monitors the reception of terms and can either generate the most frequently mentioned keyword or provide frequency related information to filter 2.

Step 404 of receiving a client query defining an information interest of the client. The client query can include at least one term. Referring to the example set forth in FIG. 1, a client query is sent from a client system, such client system 7, via interface 13, and provided by distribution means 4 to filter 2.

Step 404 is followed by step 405 of retrieving real time terms, these real time terms are used in step 406. The real time terms are retrieved from a data base of real time terms that is constantly updated, as shown by steps 402 and 403.

Step 405 is followed by step 406 of scanning each document with at least a portion of the client query and with at least one real time term to generate a first and a second sets of relevancy values. Referring to the example set forth in FIG. 1, filter 2 accesses each document within archive 3 and calculated a first and second set of of relevancy values. Each relevancy term of the first set reflects a correlation between a term of the client query and the document. Each relevancy value of the second set reflects a correlation between a real time term and the document. The correlation can be measured in various manners such as but not limited to counting the number of times the term appeared in the document or by counting the number of times the term appeared in the document and dividing this number by the total number of words within the scanned document.

Step 406 is followed by step 408 of calculating a combination of the relevancy values of the first and second sets of each document to generate the relevancy value of each document. For example, the combination can be a sum or a weighted sum of all relevancy values.

Step 408 is followed by step 410 of providing the client system a query result reflecting the relevancy of documents. Usually, query result can include a sorted list of documents, starting from the most relevant document and ending at the least relevant document. The query result can also include only the X most relevant documents, X being predefined ay the client or by the system administrator. The query result can also provide links to the documents, or display portions of the documents.

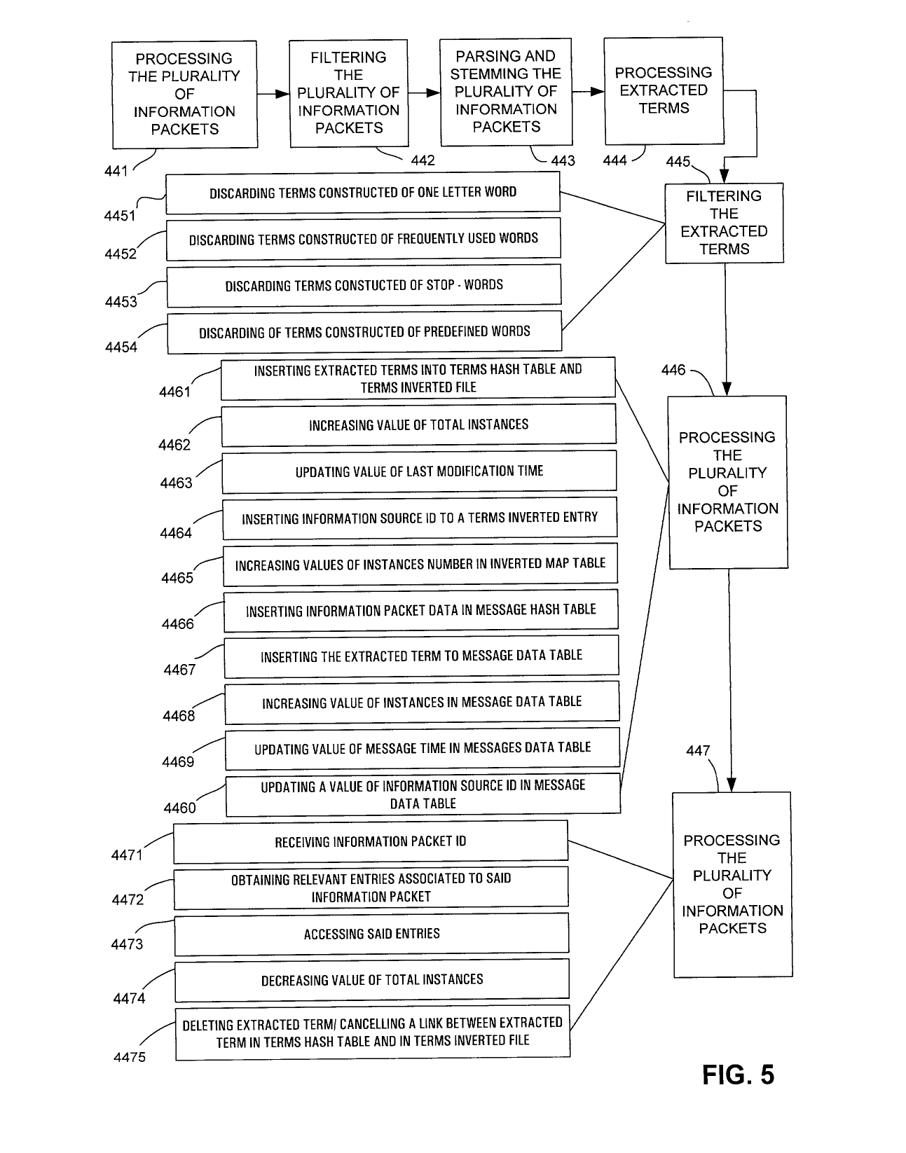

FIG. 5 illustrates in further detail one aspect of step 402 of generation real time terms from information steams. Step 402 including of at least one of the following steps: Step 441 of processing the plurality of information packets by adding control data to said information packets. The control data including of information packet identification, information source identification and time of arrival. Step 442 of filtering the plurality of information packets. Step 443 of parsing and stemming the plurality of information packets. Step 444 of processing said extracted terms by adding control information to said extracted terms. Step 445 of filtering the extracted terms to generate filtered extracted terms. Preferably, step 445 further including at least one of the following steps: step 4451 of discarding said terms constructed of one-letter words; step 4452 of discarding said terms constructed of frequently used words; step 4453 of discarding said terms constructed of stop-words and step 4454 of discarding said terms constructed of predefined words.

Step 446 of storing an extracted term in a term index data structure. Step 446 is preferably including following steps: step 4461 of inserting the extracted term into a terms hash table and into a terms inverted file; step 4462 of increasing a value of total instances in said terms inverted file; step 4463 of updating a value of last modification time in said terms inverted file; step 4464 of inserting an information source identification, said information source provided the extracted term, to a terms inverted entry map table in said terms inverted file; step 4465 of increasing a value of instances number in said inverted entry map table associated with said information source identification in said terms inverted file; step 4466 of inserting information packet data in a messages hash table; step 4467 of inserting the extracted term from said information packet to a messages data table; step 4468 of increasing a value of instances in said messages data table by one; step 4469 of updating a value of message time in said messages data table; and step 4460 of updating a value of information source identification in said message data table.

Step 446 is followed by step 447 of deleting the extracted term from the terms index data structure. Said deletion occurs either after a message from which said term was expired is stored in the message buffer for a predetermined period of time. Said term can also be deleted as a result of a garbage collection process, said process is based upon a deletion of terms that are not mentioned during a certain period.

Preferably, step 447 including the steps of: step 4471 of receiving an information packet identification, whereas the terms extracted from the information packets are to be deleted; step 4472 of reading the information packet identification from the messages hash table in said terms index data structure; step 4472 of obtaining relevant entries of said extracted terms belonging to said information packet in said messages data; step 4473 of accessing said terms inverted file for each said terms entry pointed to said terms inverted file; and step 4474 of decreasing a value of said total instances by a value of said instances number for each said terms entry pointed to said terms inverted file. Step 447 further includes of step 4475 of deleting an extracted term by a garbage collection process and canceling a link between said term in said terms hash table and said terms inverted file is canceled.

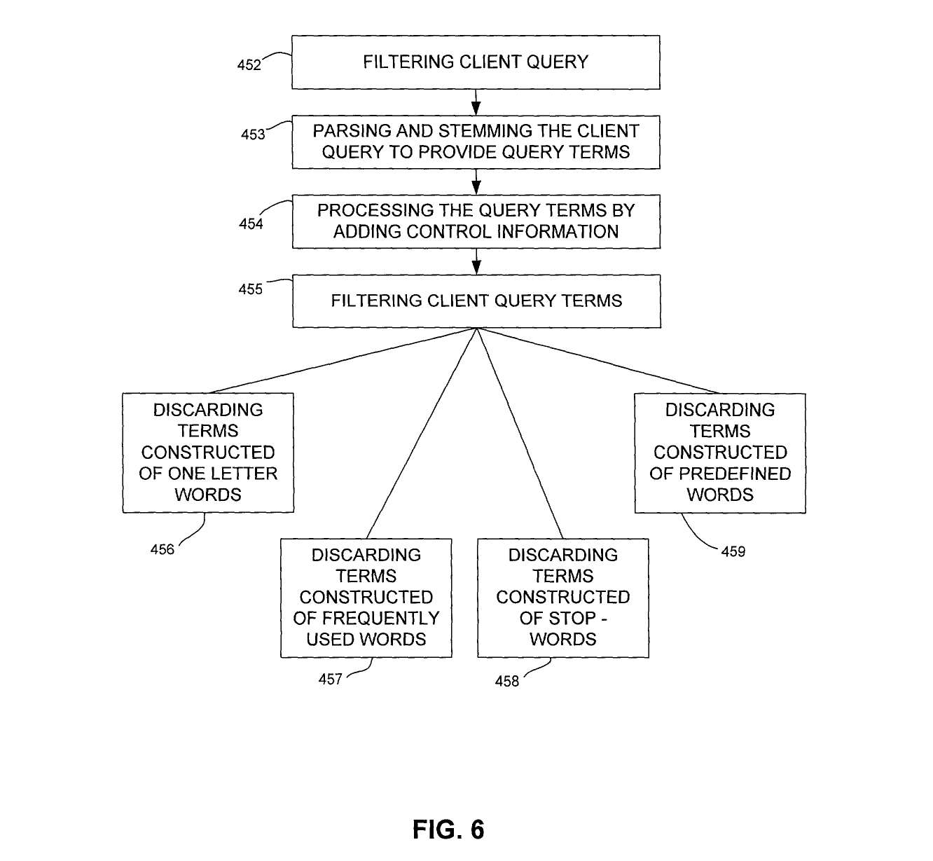

FIG. 6 illustrates another aspect of step 402 of filtering client queries to provide at least one term.

Step 402 further includes step 452 of filtering the client query by excluding client queries generated from predefined client systems. Step 452 is followed by step 453 of parsing and stemming the client query to generate query terms. Step 453 is followed by step 454 of processing the query terms by adding relevant control information to the query-terms. Step 454 is followed by step 455 of filtering said query terms. Step 455 further includes of at least one of the following steps: step 456 of discarding said terms constructed of one-letter words; step 457 of discarding said terms constructed of frequently used words; step 458 of discarding said terms constructed of stop-words; and step 459 of discarding said terms constructed of predefined words.

It will be apparent to those skilled in the art that the disclosed subject matter may be modified in numerous ways and may assume many embodiments other then the preferred form specifically set out and described above.

Accordingly, the above disclosed subject matter is to be considered illustrative and not restrictive, and to the maximum extent allowed by law, it is intended by the appended claims to cover all such modifications and other embodiments which fall within the true spirit and scope of the present invention. The scope of the invention is to be determined by the broadest permissible interpretation of the following claims and their equivalents rather then the foregoing detailed description.

We claim:

1. A method for calculating a relevancy value of a document out of a plurality of documents, the method comprising the steps of:
(a) receiving a client query defining an information interest of the client;
(b) scanning each document with at least a portion of the client query to generate a first set of relevancy values and with at least one real time term to generate a second set of relevancy values; wherein at set of relevancy values comprises at least one relevancy value; and
(c) calculating a combination of the relevancy values of the first and second set of each document to generate the relevancy value of each document.

2. The method of claim 1 wherein the step of receiving a client query is preceded by a step of receiving information packets and extracting real time terms from the information packets.

3. The method of claim 2 wherein the information packets are extracted from real time generated information streams from information sources.

4. The method of claim 2 wherein the information packets are extracted from and other client queries.

5. The method of claim 2 wherein the information packets are extracted from at least one of the members of the group consisting of: currently generated alert results; and real time received documents.

6. The method of claim 1 further comprising a step of filtering the real time terms.

7. The method of claim 6 wherein the step of filtering further comprises a step of comparing real time terms to a predefined list of keywords and discarding real time terms that do not match a keyword of the predefined list.

8. The method of claim 6 wherein the step of filtering further comprises the step of:
monitoring a reception of real time terms that match predefined keywords to provide a group of most mentioned real time terms that match the predefined keywords.

9. The method of claim 2 further comprises a step of storing the real time terms in a storage means for a predetermined period of time; wherein the step of scanning comprises a step of retrieving real time terms from the storage means; and
wherein the step of receiving a client query is preceded by a preprocessing step selected from a group consisting of:
adding control data to the information packets;
filtering the information packets;
adding control information to the filtered information packets;
extracting real time terms from the filtered information packets;
filtering the real time terms to generate real time terms; and
storing the real time terms in a storage means.

10. The method of claim 9 wherein the control data comprising of at least one parameter selected from the group consisting of: (i) information packet identification; (ii) information source identification, (iii) time of arrival, (iv) alert identification; and (v) query identification.

11. The method of claim 9 wherein the real time terms are extracted out of the filtered information packets by parsing and stemming the plurality of information packets; and
wherein the step of filtering further comprising a step selected from a group consisting of: (a) discarding said terms constructed of one-letter words; (b) discarding said terms constructed of frequently used words; (c) discarding said terms constructed of stop-words; and (d) discarding said terms constructed of predefined words.

12. The method of claim 9 wherein a reception of an information packet is followed by the steps of:
storing information packet with an associated packet identifier in the storage means;
storing real time term information representative of a reception of at least one real time term at the storage means; and
linking between the stored information packet and the real time term information.

13. The method of claim 12 wherein a deletion of an information packet is followed by a step of deleting the linked real time term information.

14. The method of claim 13 wherein the information packet are stored in a messages hash, and wherein the linked real time term information is stored in a terms hash.

15. The method of claim 14 wherein the real time term information comprising of at least one information field selected from a group consisting of:
a last modification time field, indicating a most recent time of reception of the real time term, during a predetermine period of time;
a number of channels containing term, indicating a number of information sources that provided the real time term during a predetermine period of time;
a total instances field, indicating a total amount of receptions of the real time term during a predetermine period of time; and
a terms inverted entries map, comprising of a plurality of terms inverted file entries, each entry holding information representative of a reception of the real time term from a single information source during a predetermine period of time.

16. The method of claim 15 wherein each inverted file entry comprising of at least one field selected from a group consisting of:
a channel identifier, for identifying the information source that provided the real time term during a predetermine period of time;
instances number, for indicating a total amount of receptions of the real time term from an information source during a predetermine period of time; and time of last appearance, for indicating a most recent time of reception of the real time term from an information source during a predetermine period of time.

17. The method of step 16 wherein each information packet is further associated to a message terms key map, said message key map comprising of a plurality of message characteristic entries, each message characteristic entry associated to an real time term being extracted from the information packet, said message characteristic entry comprising of at least one of the following fields selected from a group consisting of:
a term inverted file, for pointing to the term extracted information;
an instance of number, for indicating a number of time said real time term appeared in the information packet; and
an inverted file entry, for pointing to a terms inverted file entry.

18. The method of claim 1 further comprises the step of providing the client a query result reflecting the relevancy value of at lest some of the documents.

19. The method of claim 1 further comprises the step of sorting the documents according to the relevancy value of each document.

20. The method of claim 1 further comprises the step of monitoring a reception of real time terms to determine a set of most frequently received real time terms within a predefined period; and
wherein scanning each document with at least a portion of the client query and with at least one real time term out of the most frequently received real time terms.

21. The system of claim 2 wherein information packets comprise of content selected from a group consisting of: text, audio, video, multimedia, and executable code streaming media.

22. In a computing environment running on a computer platform utilized as a central server system, a method of calculating a relevancy factor of documents is operating in order to make available the capability for users of client systems connectable thereto of filtering documents in view of real time terms received by the central server system by sending client queries defining an information interest of the clients, the method comprising of the steps of:
(a) receiving a client query;
(b) scanning each document with at least a portion of the client query and with at least one real time term to generate a first set and a second set of relevancy values; wherein at set of relevancy values comprises at least one relevancy value;
(c) calculating a combination of the relevancy values of the first and second sets of each document to generate the relevancy value of each document; and
(d) providing a query result reflecting the relevancy value of the documents.

23. The method of claim 22 wherein the step of receiving a client query is preceded by a step of receiving information packets and extracting real time terms from the information packets.

24. The method of claim 23 wherein the information packets are extracted from real time generated information streams provided by information sources coupled to the central server system.

25. The method of claim 23 wherein the information packets are extracted from other client queries.

26. The method of claim 23 wherein the information packets are extracted from at least one of the members of the group consisting of: currently generated alert results; and real time received documents.

27. The method of claim 23 further comprises a step of storing the real time terms in a storage means for a predetermined period of time; wherein the step of scanning comprises a step of retrieving real time terms from the storage means.

28. The method of claim 23 wherein the step of receiving a client query is preceded by a preprocessing step selected from a group consisting of:
adding control data to the information packets;
filtering the information packets;
adding control information to the filtered information packets;
extracting real time terms from the filtered information packets;
filtering the real time terms to generate real time terms; and
storing the real time terms in a storage means.

29. The method of claim 28 wherein the control data comprising of at least one parameter selected from the group consisting of: (i) information packet identification; (ii) information source identification, (iii) time of arrival, (iv) alert identification; and (v) query identification.

30. The method of claim 28 wherein the real time terms are extracted out of the filtered information packets by parsing and stemming the plurality of information packets; and
wherein the step of filtering further comprising a step selected from a group consisting of: (a) discarding said terms constructed of one-letter words; (b) discarding said terms constructed of frequently used words; (c) discarding said terms constructed of stop-words; and (d) discarding said terms constructed of predefined words.

31. The method of claim 30 wherein a reception of an information packet is followed by the steps of:
storing information packet with an associated packet identifier in the storage means;
storing real time term information representative of a reception of at least one real time term at the storage means, said at least one real time terms extracted from the information packet; and
linking between the stored information packet and the real time term information.

32. The method of claim 31 wherein a deletion of an information packet is followed by a step of deleting the linked real time term information.

33. The method of claim 32 wherein the information packet are stored in a messages hash, and wherein the linked real time term information is stored in a terms hash.

34. The method of claim 33 wherein the real time term information comprising of at least one information field selected from a group consisting of:
a last modification time field, indicating a most recent time of reception of the real time term, during a predetermine period of time;
a number of channels containing term, indicating a number of information sources that provided the real time term during a predetermine period of time;
a total instances field, indicating a total amount of receptions of the real time term during a predetermine period of time; and
a terms inverted entries map, comprising of a plurality of terms inverted file entries, each entry holding information representative of a reception of the real time term from a single information source during a predetermine period of time.

35. The method of claim 34 wherein each inverted file entry comprising of at least one field selected from a group consisting of:
a channel identifier, for identifying the information source that provided the real time term during a predetermine period of time;
instances number, for indicating a total amount of receptions of the real time term from an information source during a predetermine period of time; and time of last appearance, for indicating a most recent time of reception of the real time term from an information source during a predetermine period of time.

36. The method of step 35 wherein each information packet is further associated to a message terms key map, said message key map comprising of a plurality of message characteristic entries, each message characteristic entry associated to an real time term being extracted from the information packet, said message characteristic entry comprising of at least one of the following fields selected from a group consisting of:
a term inverted file, for pointing to the term extracted information;
an instance of number, for indicating a number of time said real time term appeared in the information packet; and
an inverted file entry, for pointing to a terms inverted file entry.

37. The method of claim 22 further comprises the step of providing the client a query result reflecting the relevancy value of at lest some of the documents.

38. The method of claim 22 further comprises the step of sorting the documents according to the relevancy value of each document.

39. The method of claim 22 further comprises the step of monitoring a reception of real time terms to determine a set of most frequently received real time terms within a predefined period; and
wherein scanning each document with at least a portion of the client query and with at least one real time term out of the most frequently received real time terms.

40. The system of claim 23 wherein information packets comprise of content selected from a group consisting of: text, audio, video, multimedia, and executable code streaming media.

41. The method of claim 2 further comprising a step of filtering the real time terms.

42. The method of claim 41 wherein the step of filtering further comprises a step of comparing real time terms to a predefined list of keywords and discarding real time terms that do not match a keyword of the predefined list.

43. The method of claim 41 wherein the step of filtering further comprises the step of:
monitoring a reception of real time terms that match predefined keywords to provide a group of most mentioned real time terms that match the predefined keywords.

44. A method for calculating a relevancy value of a document out of a plurality of documents, the method comprising the steps of:
receiving information packets;
extracting real time terms form the information packets;
storing the real time terms;
receiving a client query defining an information interest of the client;
scanning each document with at least a portion of the client query and with at least one real time term to generate a first and a second sets of relevancy values; and
calculating a combination of relevancy values of the first and second sets to generate the relevancy value of each document.

45. The method of claim 44 wherein the real time terms are extracted from a group consisting of:
real time generated information streams provided by information sources;
other client queries;
currently generated alert results; and
real time received documents.

46. The method of claim 44 further comprising a step of filtering the real time terms.

47. The method of claim 46 wherein the step of filtering further comprises a step of comparing real time terms to a predefined list of keywords and discarding real time terms that do not match a keyword of the predefined list.

48. The method of claim 46 wherein the step of filtering further comprises the step of:
monitoring a reception of real time terms that match predefined keywords to provide a group of most mentioned real time terms that match the predefined keywords.

49. A system for real time document filtering, the system is adapted to receive a client query originated by a client system, to receive a plurality of information packets, to extract real time terms from the information packets, and to generate query results reflecting a relevancy factor of documents of a data base of documents, the system for real time document filtering comprising:
an information packet processor, for receiving an information packet and for processing the information packet to generate at least one processed portion of the information packet;
a storage means, coupled to the information packet processor and to a storage means, for temporarily storing information representative of a reception of the at least one processed portion of the information packet, the storage means are configured to allow fast insertion and fast deletion of content;
a document storage means, for storing a plurality of documents; and
a filter, coupled to the storage means and to the document storage means, for calculating a relevancy factor of the plurality of documents and for providing a client query result representative of the calculated relevancy factor; wherein the relevancy factor reflects a correlation between (a) at least a portion of the query and (b) the at lest one processed portion of the information packet and between each document content.

50. The system of claim 49 wherein the filter is configured to filter the real time terms.

51. The system of claim 49 wherein the filter is further configured to compare real time terms to a predefined list of keywords and discard real time terms that do not match a keyword of the predefined list.

52. The system of claim 49 wherein the search engine is further configured to monitor a reception of real time terms that match predefined keywords to provide a group of most mentioned real time terms that match the predefined keywords.

53. The system of claim 49 wherein the at least one processed portion of the information packet is an at least one real time term.

54. The system of claim 49 further comprising at least one module selected from a group of modules consisting of:
a message coordinator module adapted to coordinate an handling of a plurality of information packets;
a message buffer adapted to hold temporarily the plurality of information packets;
a message filter module for filtering the plurality of information packets according to predefined rules;
a term extractor module for performing parsing and stemming on said plurality of information packets;
a terms filter for excluding real time terms according to predefined rules;
a queries coordinator module to coordinate the processing of client queries;
a query-term extractor to parse and stem incoming queries in order to extract and process operative query-terms; and
a query-terms filter for excluding specific query-terms in a predefined manner.

55. The system of claim 49 wherein the storage means is a term index data structure.

56. The system of claim 55 wherein the term index data structure is adapted to hold indexed real time terms and information packet identifiers.

57. The system of claim 56 wherein the term index data structure further comprising:
a terms hash table to hold extracted, filtered and processed terms;
a terms inverted file pointed to by said term hash table holding a terms inverted entry map;
a messages hash table to hold information packets identification;
a messages data table to hold information packets data; and
a channel map to hold a list of information sources and the related number of index terms of said information source.

58. The system of claim 57 wherein the terms inverted file further comprising:
a terms inverted entries map table;
a total instances of said term;
a number of information sources containing said term; and
a last modification time of said term.

59. The system of claim 58 further comprising:
a message terms keyed map;
an information source identification; and
an information packet time of arrival.

60. The system of claim 59 wherein the message terms keyed map further comprising:
a pointer to said terms inverted file;
an instances number of said term in said information packet; and
a pointer to said inverted file entry related to said term.

61. The system of claim 60 wherein the terms inverted entries map further comprising;
an information source identification;
an instances number of said term in said information source informational content; and
a time of last appearance of said term in said information source informational content.

62. The system of claim 49 further comprising of at least one of the following means:
adding means for adding control data to said information packets;
filtering means for the plurality of information packets;
processing means for said real time terms by adding control information to said real time terms; and
term filtering means for the real time terms to generate filtered real time terms.

63. The system of claim 49 wherein the real time terms are extracted out of the plurality of information packets by parsing and stemming the plurality of information packets; and
wherein the term filtering means are adapted to (a) discarding said terms constructed of one-letter words; (b) discarding said terms constructed of frequently used words; (c) discarding said terms constructed of stop-words; and (d) discarding said terms constructed of predefined words.

64. The system of claim 63 wherein the control data comprising of information packet identification, information source identification and time of arrival.

65. The system of claim 49 further adapted to receive an information packet, to store information packet with an associated packet identifier in an information packet storage means, store real time term information representative of a reception of at least one real time term, said at least one real time terms extracted from the information packet; and to link between the stored information packet and the real time term information.

66. The system of claim 65 further adapted to delete an information packet and delete the linked real time term information.

67. The system of claim 65 wherein information packet are stored in a messages hash, and wherein the linked real time term information is stored in a terms hash.

68. The system of claim 67 wherein the real time term information comprising of at least one information field selected from a group consisting of:
a last modification time field, indicating a most recent time in which the real time term was received;
a number of channels containing term, indicating a number of information sources that provided the real time term;
a total instances field, indicating a number of times the real time term was provided; and
a terms inverted entries map, comprising of a plurality of terms inverted file entries, each entry holding information representative of a reception of the real time term from a single information source.

69. The system of claim 68 wherein each inverted file entry comprising of at least one field selected from a group consisting of:
a channel identifier, for identifying the information source that provided the real time term;
instances number, for indicating a number of times the real time term was provided by an information source; and
time of last appearance, for indicating a most recent time in which the real time term was received from an information source.

70. The system of step 69 wherein each information packet is further associated to a message terms key map, said message key map comprising of a plurality of message characteristic entries, each message characteristic entry associated to an real time term being extracted from the information packet, said message characteristic entry comprising of at least one of the following fields selected from a group consisting of:
a term inverted file, for pointing to the term extracted information;
an instance of number, for indicating a number of time said real time term appeared in the information packet; and
an inverted file entry, for pointing to a terms inverted file entry.

71. The system of claim 49 further adapted to insert an real time term into a terms hash table and into a terms inverted file, insert an information source identification, said information source provided the real time term, to a terms inverted entry map table in said terms inverted file, insert information packet data in a messages hash table; insert the real time term from said information packet to a messages data table; increase a value of instances in said messages data table by one; and
update a value of information source identification in said message data table.

72. The system of claim 71 further adapted to extract an real time term and accordingly to perform at least one operation selected from a group consisting of increase a value of total instances in said terms inverted file;
update a value of last modification time in said terms inverted file;
increase a value of instances number in said inverted entry map table associated with said information source identification in said terms inverted file; and
update a value of message time in said messages data table.

73. The system of claim 49 further adapted to delete an information packet, and accordingly to perform at least one operation selected from a group consisting of:
receive an information packet identification, whereas the terms extracted from the information packets are to be deleted;
read the information packet identification from the messages hash table in said terms index data structure;
obtain relevant entries of said real time terms belonging to said information packet in said messages data; and
access said terms inverted file for each said terms entry pointed to said terms inverted file.

74. The system fo claim 49 further adapted to store alert criteria and to match alert criteria received and processed in the past against newly received terms to generate an alert.
